(19) United States
(12) Patent Application Publication
(10) Pub. No.: US 2023/0019454 A1
(43) Pub. Date: Jan. 19, 2023

(54) SYSTEMS AND METHODS FOR COMPUTER ANALYTICS OF ASSOCIATIONS BETWEEN STORED PRODUCTS AND COMPLETED ELECTRONIC TRANSACTION EVENTS

(71) Applicant: Worldpay, LLC, Symmes Township, OH (US)

(72) Inventor: Nicole S. JASS, Aurora, CO (US)

(21) Appl. No.: 17/933,960

(22) Filed: Sep. 21, 2022

Related U.S. Application Data
(63) Continuation of application No. 16/233,589, filed on Dec. 27, 2018.

(51) Int. Cl. G06Q 30/02; G06Q 30/06; G06Q 10/06

(52) U.S. Cl. CPC G06Q 30/0201; G06Q 10/0637; G06Q 30/0625

(57) ABSTRACT

Systems and methods are disclosed for generating analytics for products placed in virtual or physical shopping carts. In particular, the present systems and methods disclose various ways to generate and use analytics describing the relation between products that are stored in shopping carts (e.g., indicating a user’s interest in a product), and products that are actually purchased. One method includes: detecting, using a processor, a shopping cart associated with a registered user; receiving, by the processor, indication of a selected product associated with the shopping cart; receiving, by the processor, transaction data associated with the registered user; and if the transaction data includes purchase of the selected product, generating, using the processor, a first cart abandonment score; if the transaction data includes purchase of a product other than the selected product, generating, using a processor, a second cart abandonment score, the second cart abandonment score being different from the first cart abandonment score.

### CROSS-REFERENCE TO RELATED APPLICATION(S

This patent application is a continuation of and claims the benefit of priority to U.S. Nonprovisional Patent Application No. 16/233,589, filed on Dec. 27, 2018, the entirety of which is incorporated herein by reference.

### TECHNICAL FIELD

The present disclosure relates generally to the field of e-commerce transactions and, more particularly, to technology that generates consumer analytics for products placed in physical and online shopping carts. In particular, the present disclosure relates to generating analytics for understanding the relation between products that are stored in shopping carts (e.g., indicating a user’s interest in a product), and products that are actually purchased.

### BACKGROUND

Merchants have physical and virtual shopping carts in which consumers place products prior to making a purchase. Consumers may place items in online shopping carts, but not proceed to purchasing the item. This product or cart “abandonment” in the shopping carts translates to a significant loss of business opportunity. A desire exists to better understand the circumstances of such “abandonment,” in order to better understand why product sales, pricing, customer experience, fraudulent transactions, etc. may be lost.

### SUMMARY

A computer-implemented method is disclosed for generating consumer analytics for products placed in virtual or physical shopping carts. The method comprises detecting, using a processor, a shopping cart associated with a registered user; receiving, by the processor, indication of a selected product associated with the shopping cart; receiving, by the processor, transaction data associated with the registered user; and if the transaction data includes purchase of the selected product, generating, using the processor, a first cart abandonment score; if the transaction data includes purchase of a product other than the selected product, generating, using a processor, a second cart abandonment score, the second cart abandonment score being different from the first cart abandonment score.

A system is disclosed for generating consumer analytics for products placed in virtual or physical shopping carts, the system comprising: a data storage device storing instructions for generating consumer analytics for products placed in virtual or physical shopping carts; and a processor configured to execute the instructions to perform a method including the steps of: detecting, using a processor, a shopping cart associated with a registered user; receiving, by the processor, indication of a selected product associated with the shopping cart; receiving, by the processor, transaction data associated with the registered user; and if the transaction data includes purchase of the selected product, generating, using the processor, a first cart abandonment score; if the transaction data includes purchase of a product other than the selected product, generating, using a processor, a second cart abandonment score, the second cart abandonment score being different from the first cart abandonment score.

A non-transitory computer readable medium is disclosed for use on at least one computer system containing computer-executable programming instructions for generating consumer analytics for products placed in virtual or physical shopping carts, the method comprising: detecting, using a processor, a shopping cart associated with a registered user; receiving, by the processor, indication of a selected product associated with the shopping cart; receiving, by the processor, transaction data associated with the registered user; and if the transaction data includes purchase of the selected product, generating, using the processor, a first cart abandonment score; if the transaction data includes purchase of a product other than the selected product, generating, using a processor, a second cart abandonment score, the second cart abandonment score being different from the first cart abandonment score.

It is to be understood that both the foregoing general description and the following detailed description are exemplary and explanatory only and are not restrictive of the detailed embodiments, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1A-1D depict various outcomes of scenarios in which a consumer has placed products into shopping cart of a given merchant, according to one or more embodiments.

FIG. 2A depicts an exemplary purchase tracking system diagram for providing the data to compute a cart abandonment score, according to one or more embodiments.

FIG. 2B depicts an exemplary payment system diagram configured to use the cart abandonment score in authorizing or declining transaction requests, according to one or more embodiments.

FIG. 2C depicts an exemplary financial transaction services processor of an exemplary purchase tracking system diagram, according to one or more embodiments.

FIGS. 3A-3C depict block diagrams of various components of the financial transaction services processor of FIG. 2C, according to one or more embodiments.

FIG. 4 is a flow diagram of an exemplary method for generating aggregated cart abandonment scores, according to one or more embodiments.

FIG. 5 is a flow diagram of an exemplary method for generating aggregated cart abandonment scores associated with products, according to one or more embodiments.

FIG. 6 is a diagram of an example computing environment, according to one or more embodiments.

### DETAILED DESCRIPTION

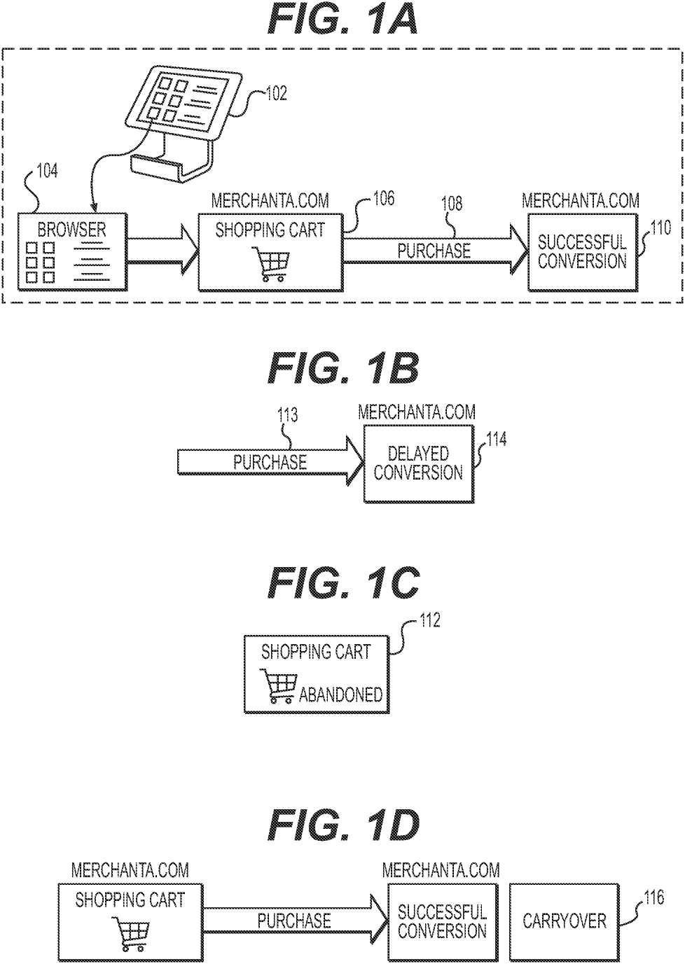

Various non-limiting embodiments of the present disclosure will now be described to provide an overall understanding of the principles of the structure, function, and use of systems and methods disclosed herein related to the generation of consumer analytics for products placed in online shopping carts. One or more examples of these non-limiting embodiments are illustrated in the selected examples disclosed and described in detail with reference made to FIG. 1A-5 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting environments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc. either are related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. may be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment" in places throughout the specification are not necessarily all referring to the same embodiment. Furthermore, the particular features, structures, or characteristics may be combined in any suitable manner in one or more embodiments.

Throughout this disclosure, references to components or modules generally refer to items that logically may be grouped together to perform a function or group of related functions. Like reference numerals are generally intended to refer to the same or similar components. Components and modules may be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack.

Increasingly, merchants offer physical or digital interfaces for users to store items/products that they may wish to purchase. Physical interfaces may take the form of physical repositories or products physically being put on hold or on reserve. Digital interfaces may include online shopping carts, registries, reservations, etc. Merchants may also offer a mix of physical and digital interfaces, e.g., where users may go to a physical store (e.g., a brick-and-mortar site) and scan items into a digital shopping cart for later purchase or as a registry. Accordingly, merchants may have knowledge of the products users store in a shopping cart. At the same time, merchants may handle transactions of products stored in carts, e.g., when a user opts to purchase one or more items in a cart. However, merchants currently have little insight or predictive ability regarding factors that may cause a user to not follow through with purchasing one or more items stored in a cart.

Many consumers use physical and virtual shopping carts, as repositories of products, both immediately prior to purchase and for an extended period of time. For example, a user in one scenario may add one or more items into a shopping cart, then proceed to purchase all the items placed in the shopping cart. In another embodiment, a user may add one or more items into a shopping cart and simply store the items for a period of time in the shopping cart, the period of time extending for days, weeks, or months. For example, users may use shopping carts as “wish lists,” opting to not immediately purchase the items in their carts. The pricing or availability of the items may change while the product is stored in the cart. For example, an item may be discounted for a period of time (or permanently) while the product is stored in the cart, or the product may go out of stock or be restocked while the product is stored in the cart. Some users may have the habit to use shopping carts as “wish lists,” more so than other users. In some cases, a user may proceed to purchase some items in his/her shopping cart while refraining from purchasing other items in the cart (e.g., "carryover items), the user may continue to add items into the cart, and the user may replace some items with comparable items. Purchasing of the items in the cart may be carried out by the user, or by other users (e.g., as gifts in a registry).

Some products may have a tendency to be “wish list” items that are added to carts but never purchased, while other products may have the tendency to be purchased immediately. In some cases, a merchants may also be better than a comparable merchant at “closing the deal,” e.g., a first merchant may experience little discrepancy between products added to cart and products actually purchased whereas a competing, second merchant may experience a large gap between products that are added to carts and actual product sales. This may be due to pricing or promotions, where users may either lose interest in the item with the second merchant or end up purchasing the product(s) from merchants other than the second merchant. Consistency between products in a cart and products purchased may also fluctuate with certain time periods. For example, during the holiday season, special occasions (e.g., birthdays, anniversaries, etc.), at night, on weekends, almost all the products stored in a cart may be purchased. Weekdays, however, may shop an increase in the disparity between the number of products stored in a cart and the number of products purchased.

Accordingly, a desire exists to better understand why a user may not actually one or more purchase products that he/she had stored in a shopping cart, e.g., “cart abandonment.” The items stored in carts, relative to the items actually purchased by a user may provide a wealth of information to merchants, financial institutions, third party vendors (e.g., fraud analysis vendors or transaction facilitation vendors), etc. Such parties may be interested in the factors that may drive why a product is not actually purchased from a merchant’s shopping cart. Such factors may include, for example, purchase or interest in a similar product, the pricing of the product, the availability of the product (e.g., if the product is out of stock), purchase of the product from another merchant, the user’s tender/payment request being refused, etc.

A desire also exists to better predict such practices and factors, in the collective. For instance, a desire exists to better understand cart abandonment practices for various products/categories of products, merchants, demographics, periods of time, etc. Such understanding may provide metrics for evaluating the performance of a merchant, a product, a category of products, an advertisement or ad campaign, a promotion or discount, etc.

The presently disclosed system and methods are generally directed to providing a cart abandonment score indicating a user’s likelihood to abandon (or not purchase) a product that he/she places into a cart. The cart abandonment score may comprise an aggregate cart abandonment score. In one embodiment, an aggregate cart abandonment score may serve as a performance metric for a given merchant, e.g., indicating the percentage of items stored in the carts of the merchant are abandoned, (or, not purchased). In one embodiment, merchant(s) may use their cart abandonment scores to benchmark their performance against competitors or other merchants in the same industry. For example, a first merchant may have an aggregate cart abandonment score of 30% while a competitor may have an aggregate cart abandonment score of 50%. Since the first merchant has a lower cart abandonment score than its competitor, the first merchant may be performing better than its competitor from the standpoint that the first merchant’s customers complete 70% of the purchases they plan to make with the first merchant, whereas customers of the competitor complete only 50% of the purchases they plan to make.

In another embodiment, an aggregate cart abandonment score may serve as a performance metric for a given product, e.g., indicating the percentage of times that a product is actually purchased, after being stored in a cart. For example, if a product’s aggregate cart abandonment score is 20%, that product may have a higher performance or popularity than a product whose aggregate cart abandonment score is 90%. The scores may indicate that the former product is purchased 80% of the time, while the latter product is added to a cart, but only purchased 10% of the time. In some cases, the disclosed systems and methods may further provide metrics that indicate why a product may frequently be added to a cart, but not purchased. The metrics may also provide indications of why another product may be rarely added to a cart, but it may be purchased (or not abandoned) almost every single time it is stored to a cart. For example, the disclosed systems and methods may detect related products and evaluate relative aggregate cart abandonment scores of the related products. The related products may include products that may be bought together and/or products that may be comparable, replacement products for one another. The systems and methods herein may further provide aggregate cart abandonment scores as performance metrics of the related products, relative to one another.

By extension, the systems and methods herein may provide aggregate cart abandonment scores as performance metrics of categories of goods or industries. For example, a merchant may carry multiple categories of goods, e.g., “sporting goods” and “outdoor gear.” Cart abandonment scores (either of products added to cart/purchased of the merchant or other merchants) may indicate that “outdoor gear” products have a lower cart abandonment score than “sporting goods.” Merchant(s) may then use such information to help decide what goods to stock, or the amount of inventory to keep in stock for various categories of goods.

In yet another embodiment, aggregate cart abandonment scores may serve as performance metrics for a form a tender, e.g., indicating the percentage of times that a tender is used in a successful purchase, out of all of the transactions in which the tender is used. In some cases, carts (or products in carts) may be abandoned because the user’s tender was refused. The refusal may be due to detection that the tender usage might be fraudulent. In one embodiment, transactions may be approved or denied based on aggregate cart abandonment scores. For example, an association between a form of tender and high aggregate cart abandonment scores may raise the likelihood that a transaction authorization request using the form of tender may be denied.

In accordance with the systems and methods described herein, a profile for the consumer may be generated and stored by a profiler computing system subsequent to the consumer making a purchase. The purchase may be made physically (e.g., though scanning or swiping a payment vehicle) or through interactions with a networked user device or computing device (e.g., laptop, a desktop computer, a smart appliance such as a smart television, a mobile phone, or any other mobile device, such as a tablet computer, and so forth). As described in more detail below, during the online purchase event, the purchaser may provide transaction data (e.g., purchase information) to a financial transaction services processor of a merchant, including payment vehicle information, over a network. Additionally, other information may be provided to the financial transaction services processor over the network during the course of the transaction and, in some embodiments, may be provided after the conclusion of the transaction. Such information may include a tracking element associated with the purchaser and/or a networked user device of the purchaser. For example, in some embodiments, the tracking element may be a device identifier of the networked user device of the purchaser. This device identifier may be used as part of the fraud prevention services of the financial transaction services processor or the payment networks (e.g., Visa® or MasterCard®). The device identifier may be, for example, one or more of a source IP address, a MAC address, a device ID, a device fingerprint, a browser fingerprint, a unique identifier, a cookie, an OS configuration, a static HTTP, or any other suitable type of identifier corresponding to the networked user device (e.g., computing device) of the purchaser.

Additionally or alternatively, the tracking element may be an identifier associated with the purchaser. For example, in some embodiments, the tracking element may be embodied as, or otherwise include, a name, an email address, a primary account number (PAN), a postal address, a phone number, a loyalty account number, a username, a merchant-assigned user ID, browser and plug-in variables associated with consumer and consumer payment profiles, and/or any other unique identifier associated with the purchaser. Additionally, in accordance with the present disclosure, the financial transaction services processor may provide information from the online or initial purchase event to the profiler computing system.

Accordingly, in view of the systems and methods described herein, and as described in more detail below, aggregated cart abandonment scores may provide insights on factors that contribute to purchase (or abandonment) of products saved in shopping carts.

FIG. 1A schematically depicts a scenario in which a user has placed products into shopping cart of a given merchant, with a subsequent purchase transactions leading to a successful conversion, which may include a delayed conversion. The conversion may be a sale of the product. The shopping cart may be an online shopping cart, e.g., of a merchant website, where a user may place products into the virtual shopping cart and place orders. Alternately or in addition, the shopping cart may be in a physical setting, where a user (or employee of the merchant) may scan one or more items that the user seeks to purchase. A lack of conversion may constitute an “abandonment.” This may entail a scenario where the user does not purchase the product. For example, the user does not purchase the product at all, or the user purchases the product from a competitor, rather than the given merchant, either at all, or the user does not purchase the product from the merchant.

Computer 102 is shown with browser 104 in which a consumer may interact with e-commerce merchants for the purchase of products. While computer 102 is illustrated as a desktop computer, in may be appreciated that a consumer may interact with e-commerce merchants using other devices that connect to the Internet (e.g., tablets, mobile phones, and the like). After browsing through the online merchant’s web portal (e.g., Merchant A.com), the consumer places a product in shopping cart 106 to make a purchase. The consumer provides Merchant A.com with their payment vehicle information to complete purchase 108 of the product placed in shopping cart 106, resulting in a successful conversion 110.

FIG. 1B depicts a scenario in which a consumer stores one or more products in shopping cart 106 and does not immediately purchase the products. If the consumer purchases the product during a shopping session at a later point in time from when he/she first added the products into shopping cart 106, the purchase 113 may comprise a delayed conversion 114. While a delayed conversion 114 may still comprise a successful conversion 110, there may be factors of interest to merchant(s) on how to ensure that a delay results in a delated conversion 114 or successful conversion 110, rather than an abandonment 112 of the shopping cart. FIG. 1C depicts a scenario in which a consumer initiates a shopping cart or stores one or more products in a shopping cart, only to abandon the cart and not purchase any items in the cart.

FIG. 1D depicts a scenario in which the consumer places multiple products in an online shopping cart and purchases some items of the cart, and not others. In some cases, the remaining cart could be later abandoned, where a user abandons an entire cart at once or removes one or more items from the cart until it is empty. In other cases, the remaining cart could continue to store the unpurchased products. These products could be carryover 116. The user may keep these products in the cart as he/she is trying to decide whether to purchase the product, or the user may be waiting for a certain timing or sales promotion before purchasing the product. During this process, the user may also add more products to the cart. Overall, merchants and manufacturers may be interested in the circumstances that may cause a user to abandon a cart (or product) in some cases, while completing a conversion in others.

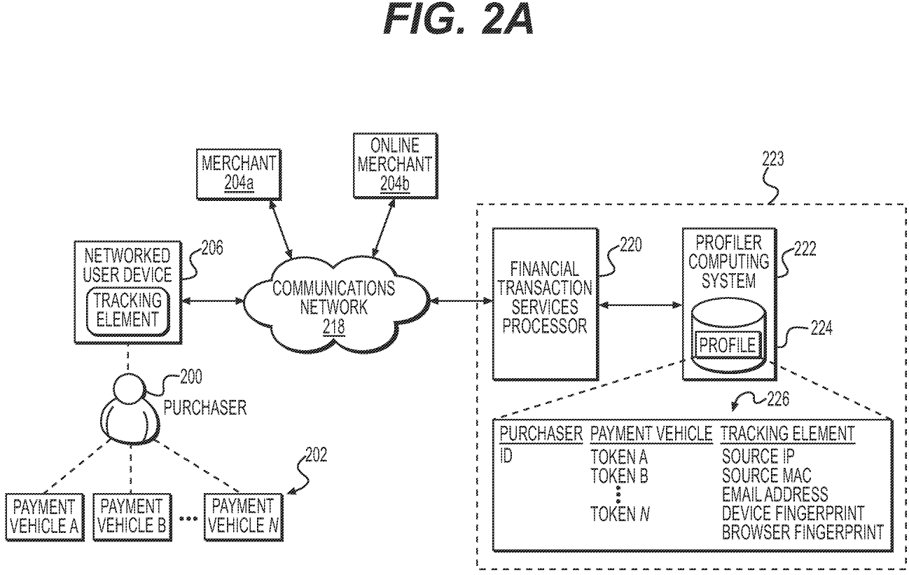

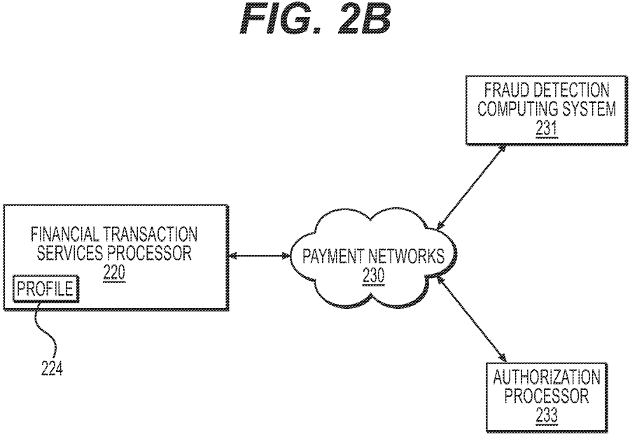

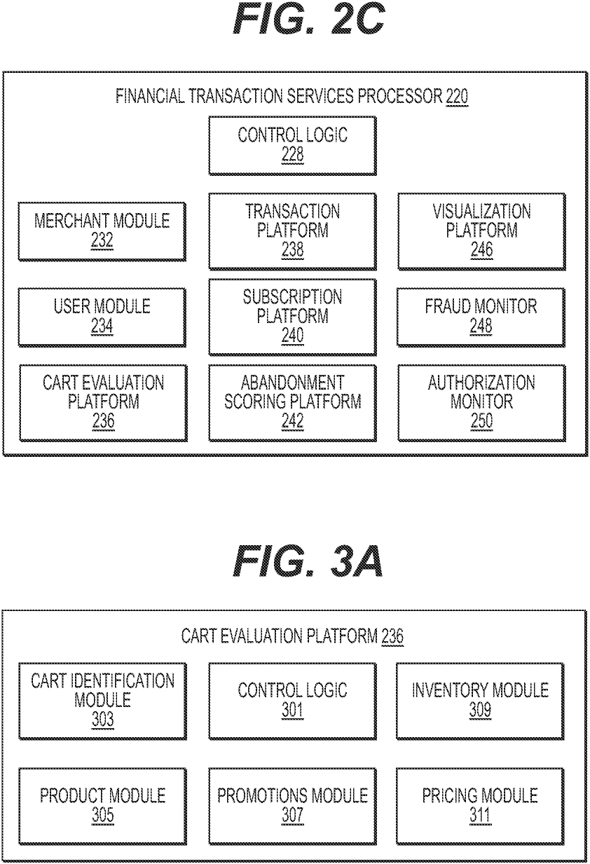

FIG. 2A depicts an exemplary purchase tracking system diagram which may provide the data to compute a cart abandonment score, according to one embodiment. In one embodiment, a purchaser 200 is shown that is associated with payment vehicles 202, which are depicted as Payment Vehicles A-N. As is to be appreciated, the payment vehicles 202 may include any type of payment vehicle that may be utilized to initiate a payment transaction. Unless otherwise specified herein, “payment vehicle” includes (1) a physical card including a plastic or paper card with a magnetic stripe, bar code or other indicator indicative of an account number or other account indicative information, and/or (2) a virtual card, such as a display or screenshot for a mobile phone or for another portable device (e.g., a flash drive, smart chip, a laptop or portable computer), or for a computer device (e.g., a desktop computer) in combination with data indicative of an account number or other account indicative information. Data associated with the cards may include an encrypted or unencrypted account number or other encrypted or unencrypted account indicative information and/or encrypted or unencrypted information associated with a particular card, issuer, creator, or group of merchants. It is also contemplated that the card may have multiple embodiments or forms. For example, the card may be a physical card (e.g., in the form of magnetic striped plastic card or an EMV card), a virtual card (e.g., in the form of a display on a smart phone), or both. In embodiments in which the card is a virtual card, the corresponding account information (e.g., account number) would initially be provided to the consumer and the consumer would communicate the account information to the merchant. The virtual card may be communicated by displaying a display or screenshot, and/or by transmitting a signal, such as by using NFC (Near Field Communication) technology or other secure transport technologies to complete the transaction with the selected merchant. Optionally, the virtual card may have a display element (e.g., a bar code or string of numbers) which identifies the account number associated with the card. Alternatively, the virtual card may have display elements relating to the merchants that accept the card. Thus, whether the card is physical or virtual, it communicates account information.

Purchaser 200 may utilize a networked user device 206 to communicate with one or more merchants 204 (including brick-and-mortar merchant 204a and online merchant 204b) through a communications network 218 (e.g., the Internet, a secure network, etc.). Purchaser 200 may refer to any customer or user who may interface with merchants 204. The networked user device 206 may be any suitable computing device that facilitates network communications, such as, for example, a laptop computer, a tablet computer, a desktop computer, a smart television, a smart appliance, a mobile computing device, a gaming device, a wearable computing device, and so forth. When interacting with merchant 204, networked user device 206 may be associated with a tracking element. The tracking element may be, for example, an IP address, a MAC address, a device fingerprint, a browser fingerprint, or a unique identifier associated with networked user device 206. Additionally or alternatively, the tracking element may be an identifier associated with purchaser 200. For example, in some embodiments, the tracking element may be embodied as, or otherwise include, an email address, a postal address, a phone number, a loyalty account number, a username, and/or any other unique identifier associated with purchaser 200. Through a web browser executing on networked user device 206 or through other specialized applications executing on networked user device 206 (sometimes referred to as apps), purchaser 200 may initiate purchase events with one or more of merchants 204.

Merchant 204 may present a payment interface (e.g., a payment screen, a POS, etc.) to purchaser 200 in which information for one or more of payment vehicles 202 is entered. The payment interface can, in turn, communicate with financial transaction services processor 220 with appropriate authorization messaging. Financial transaction services processor 220 may communicate with various payment networks 230, to seek authorization for the purchase event at merchant 204, e.g., from fraud detection computing system 231 and authorization processor 233 (as shown in FIG. 2B). In some embodiments, financial transaction services processor 220 may include a transaction database that stores important transaction data associated with the payment vehicles 202. The transaction data may comprise at least one of a merchant’s ID, transaction location, terminal information, source IP address, date and time of the transaction, device information, transaction amount of the purchase, and payment card information. The transaction database may comprise tables containing source ID, terminal ID, date and time, IP address, location, and transaction amount for the transactions associated with payment vehicles 202. In an example embodiment, the transaction may be for purchase of an item or a service, or for a withdrawal of cash.

Information based on the transaction may also be provided to a profiler computing system 222. In some embodiments, the profiler computing system 222 may be a computing system separate from the financial transaction services processor 220 and operated by a separate entity. In other embodiments, the profiler computing system 222 is a component of the financial transaction services processor 220 and operated by the same entity, as indicated by dashed box 223.

The information provided to the profiler computing system 222 may be used to build a profile 226 for purchaser 200. The profile 226 may be stored in a profile data store 224. The profile data store 224 may be maintained by the profiler computing system 222, as is shown, maintained by the financial transaction services processor 220, or maintained by any other suitable device or entity, such as a data aggregator computing system. Profile 226 may comprises a unique identifier hash recognizing the profile of an individual, primary account numbers (e.g., PANs) or other identifiers of payment vehicles (e.g. debit, credit cards) associated with the individual, personally identifiable information (PII), and/or data/analysis of an individual’s spending habits, geographic area, and fraud activities reported on the cards associated with the individual. In an example embodiment, the personally identifiable information (PII) about the individual involves at least one of his/her name, email address, date of birth, social security number, and physical address.

The format and content of the profile 226 may vary, but generally, the profile 226 provides a linkage of the payment vehicle(s) 202 used during a purchase event to a tracking element (e.g., device ID or purchaser ID) of the networked user device 206 and/or the purchaser 200. The payment vehicle information as stored in the profile 226 may be tokenized, as may be required by relevant data privacy standards. Over time, as the purchaser 200 makes additional purchases with the same or different payment vehicles 202 using the same or different networked user devices 206, the profile 226 may be updated accordingly. Furthermore, in some embodiments, the profile 226 may utilize householding techniques to link a plurality of different purchasers to the same networked user device 206 and/or the same collection of payment vehicles 202.

FIG. 2B depicts an exemplary payment system diagram which may use the cart abandonment score in authorizing or declining transaction requests, according to one or more embodiments. As previously discussed, financial transaction services processor 220 may communicate with various payment networks 230 to seek authorization for payment of purchase event with merchant 204. Authorization may be evaluated or provided based on feedback from fraud detection computing system 231 and authorization processor 233. In one embodiment, fraud detection computing system 231 may be operated by an acquirer processor, issuer processor, card issuer, or any other financial institution. The fraud detection computing system 231 may be operated by another entity or operated independently. In any event, fraud detection computing system 231 may be configured to intercept authorization requests sent across payment network 230, or otherwise receive data about payment transactions sent between merchants 204 and financial institutions. In one embodiment, an authorization processor 233 that handles financial transactions may transfer payment between the financial institution 140 of purchaser 200 and that of merchant(s) 204.

In one embodiment, consumer 200 may submit payment information to a payment interface of merchant 204 by entering payment vehicle information (e.g., information related to a credit card, debit cart, fund wiring service, online currency, etc.), accessing stored payment information (e.g., where a user may store his/her payment vehicle information with a user profile or registration on a merchant interface), swiping his/her payment card, inserting his/her chip-based payment card, through wireless near field communication (NFC), through a payment app, via a Quick Response code (“QR” code), etc., or by any other suitable means. The merchant interface may send a payment authorization request by way of payment network 230 to an authorization processor 233 (e.g., at a financial institution). Alternatively, such a request may be sent by a component that controls a flow of a transaction, such as point of sale (POS) engine. The authorization processor 233 may request, by way of payment network 230, an electronic transfer of funds from the received funds to the financial institution associated with merchant 204.

In general, a fraud detection computing system 231 may be operated by an authorization processor (including authorization processor 233), issuer processor, card issuer, or any other financial institution. The fraud detection computing system 231 may be operated by another entity or operated independently. In any event, fraud detection computing system 231 may be configured to intercept authorization requests sent across payment networks 230, or otherwise receive data about payment transactions sent between merchants 204 and financial institutions.

In one embodiment, merchant 204 may send (or an acquirer processor may receive) an authorization request for an online or brick-and-mortar transaction over a wireless network, e.g., communications network 218. Such an authorization request may be intercepted by or otherwise received by fraud detection computing system 231. Fraud detection computing system 231 may retrieve identifying information associated with the transaction and transaction data from the authorization request before the authorization request is routed to a financial institution. The identifying information may include, for example, personally identifiable information (PII) of an individual associated with the transaction, a device fingerprint, device-specific information, an originating IP address, which may be determined through IP proxy piercing, etc. Further, fraud detection computing system 231 may search a profile database, e.g., profile data store 224 for a fraud detection profile associated with the identifying information associated with the transaction.

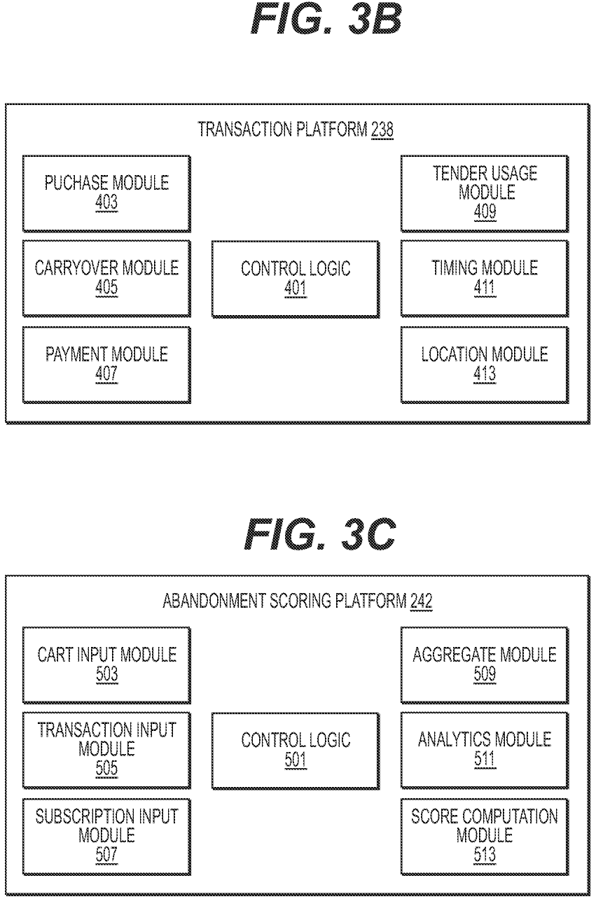

In an example embodiment, if the fraud detection computing system 231 finds a profile associated with the identifying information associated with the transaction in profile data store 224, an acquirer processor may further analyze the transaction against the profile to determine whether the online or in-store transaction is fraudulent. For example, the fraud detection computing system 231 may detect an aggregate cart abandonment score associated, at least, with a tender (e.g., a payment vehicle), a merchant, a product, a user, or a combination thereof. The aggregate cart abandonment score may be computed and stored by financial transaction services processor 220. The financial transaction services processor 220 is described in further detail in FIGS. 2C, 3A, 3B, and 3C.

FIG. 2C is a block diagram of an exemplary model of financial transaction services processor 220 for managing transactions, according to an exemplary embodiment of the present disclosure. In one embodiment, financial transaction services processor 220 may communicate with fraud detection computing system 231 and authorization processor 233 over payment network 230 (e.g., using any suitable modem, wireless adapter, etc.). As shown in FIG. 2C, financial transaction services processor 220 may include control logic 228, merchant module 232, user module 234, cart evaluation platform 236, transaction platform 238, subscription management platform 240, abandonment scoring platform 242, visualization platform 244, fraud monitor 248, and authorization monitor 250. Control logic 228 may direct the functions and interactions among the various modules.

In one embodiment, the control logic 228 and merchant module 232 may monitor various merchants that operate via financial transaction services processor 220 (e.g., merchants 204 of FIG. 2A). In one embodiment, control logic 228 and merchant module 232 may manage the inventory of merchants that operate via financial transaction services processor 220, for example, by tracking the goods sold by each merchant, the type of merchant (e.g., online only, brick-and-mortar, both online and brick-and-mortar, luxury, specialty, handmade goods, franchise, boutique, family-owned, bulk, membership, etc.), the location, etc.

Alternately or in addition, control logic 228 and merchant module 232 may track the various interfaces provided by each merchant. For example, a merchant may provide various interfaces at which a user may access a shopping cart. Exemplary interfaces include, for example, an interactive user interface presented by a merchant’s mobile app, a physical store, a designated merchant webpage, a sales page hosted on a portal, etc. Control logic 228 and merchant module 232 may identify that a first set of interfaces all correspond to a single merchant and another set of interfaces correspond to a second merchant. Control logic 228 and merchant module 232 may also detect when a merchant initiates a new interface, e.g., if a merchant launches a mobile app or a virtual “storefront” as part of an online marketplace. The control logic 228 and merchant module 232 may then initiate tracking of the new interface and track the new interface as an interface of the merchant.

Control logic 228 and merchant module 232 may also track each merchant’s activity. For example, control logic 228 and merchant module 232 may detect when merchants have promotions, restock, roll out new items, etc. Further, control logic 228 and merchant module 232 may manage various operational settings of each merchant’s different accounts or user accounts. For example, control logic 228 and merchant module 232 may track whether cart abandonment scores are lower on one merchant interface versus another interface (e.g., a merchant’s website versus the merchant’s mobile app). Control logic 228 and merchant module 232 may also detect and track cart abandonment scores and breakdowns favored by each merchant, or by one or more merchants. For example, control logic 228 and merchant module 232 may detect whether merchant(s) prefer cart abandonment scores that show the performance of merchants, user behavior by demographic or timing (e.g., time of day or year), product(s), categories of products, or payment vehicles/tender.

In one embodiment, control logic 228 and user module 234 may monitor user activity, e.g., given by user device 206. For example, control logic 228 and user module 234 may store a profile (e.g., profile 226) for each user. The profile may include a tracking element (e.g., the device ID or purchaser ID) to a payment vehicle used by the user during any purchase transaction. In some embodiments, more than one tracking element may be linked to a particular user. Furthermore, as is to be appreciated, in view of Payment Card Industry (PCI) requirements, various tokenization techniques may be used to mask personally identifiable information without departing from the scope of the present disclosure. In this regard, if the control logic 228 and user module 234 may link a tracking element to a token, it is to be understood that the tracking element is still considered to be linked to the payment vehicle. The control logic 228 and user module 234 may continue to augment the profile over time as additional online transactions are made by the user. For example, if the user initiates a second transaction from the same networked user device using a second payment vehicle, the second payment vehicle may be added to the user’s profile. In that way, the second payment vehicle may be linked to the tracking element.

In one embodiment, control logic 228 and cart evaluation platform 236 may track contents of a cart (e.g., a user’s shopping cart for a given merchant). Control logic 228 and cart evaluation platform 236 may further monitor user interactions with the cart. The cart evaluation platform 236 is described in more detail in FIG. 3A. In one embodiment, control logic 228 and transaction platform 238 may track transactions and payments made in association with the carts monitored by cart evaluation platform 236. For example, control logic 228 and transaction platform 238 may chronicle any purchases of items in the carts and log various characteristics of the purchase, including but not limited to the payment amount, timing of the payment, payment vehicle used, amount of time the item spent in the cart, etc. The transaction platform 238 is described in more detail in FIG. 3B.

In one embodiment, control logic 228 and subscription management platform 240 may manage the various parties interested in aggregate cart abandonment scores (or aggregate tender-switching scores). For example, financial transaction services processor 220 may include a service that provides aggregated analyses on transactions conducted on payment networks 230. The service may be provided as a subscription service, where parties may subscribe to receive reports or access a portal of dynamic reports. Exemplary parties may include merchants interested in better analyzing their inventory, market research entities, investors, suppliers, apps, financial services vendors, etc. Exemplary parties may also include third party advertisement services, which may use aggregate cart abandonment scores to fashion advertisement campaigns, e.g., for example, in urging users to purchase items that are already added in their carts. Exemplary parties may further include fraud detection services or financial institutions, which may use aggregate cart abandonment scores for fraud detection, or to approve/deny payment authorization requests.

In one embodiment, control logic 228 and abandonment scoring platform 242 may compute at least one abandonment score, to report to each of the subscribers. The control logic 228 and abandonment scoring platform 242 may aggregate data gathered and analyzed by the cart evaluation platform 236 and the transaction platform 238 to generated aggregated cart abandonment score(s), as dictated by the subscription management platform 240. The abandonment scoring platform 242 is described in more detail in FIG. 3C.

In one embodiment, control logic 228 and visualization module 244 may create different visualizations of the computed cart abandonment scores. In some cases, the visualizations may be generated, depending on the criteria of the subscription. In one embodiment, the control logic 228 and visualization module 244 may output one score (e.g., a number). In another embodiment, the control logic 228 and visualization module 244 may produce a dashboard that may show different graphics of variations of cart abandonment scores, depending on time of day, user, user demographic, merchant demographic, product, product category, etc. In some cases, the graphics may be interactive, e.g., in a dashboard where subscriber(s) may toggle between different visualizations and analyses.

In one embodiment, control logic 228 and fraud monitor 248 may interface with fraud detection computing system 231 and/or authorization processor 233 to evaluate the possibility of fraud in a transaction related to a cart. In some cases, control logic 228 and authorization monitor 250 may further detect instances where authorization is denied, and find trends in the contextual characteristics of authorization denial, whether it be for a certain type of product, related to certain merchants, for users of a particular age group, etc.

FIG. 3A is a block diagram of an exemplary model of a cart evaluation platform for detecting user actions related to a cart, according to an exemplary embodiment of the present disclosure. In one embodiment, cart evaluation platform 236 may communicate with a fraud detection computing system 231 and authorization processor 233 over payment network 230 (e.g., using any suitable modem, wireless adapter, etc.). As shown in FIG. 3A, cart evaluation platform 236 may include control logic 301, cart identification module 303, product module 305, promotions module 307, inventory module 309, and pricing module 311. Control logic 301 may direct the functions and interactions among the various modules. Additionally or alternatively, the merchant’s web servers and/or servers may provide at least some of the data aggregation performed by control logic 301.

In one embodiment, control logic 301 and cart identification module 303 may identify, track, and integrate each instance of a cart available from a given merchant. For example, a merchant may offer various interfaces for a user to interact with the merchant, for example, a mobile app, a website, a physical store, a marketplace available on a hosted site, etc. Each of those interfaces may provide the user with access to a cart where the user may select items to store in the cart, for later purchase. In one embodiment, control logic 301 and cart identification module 303 may detect each instance of the cart, so that the user’s cart is available and consistent across each interface. For example, the control logic 301 and cart identification module 303 may consolidate carts such that if the user stores a product to his/her cart using the merchant’s mobile app, the product will still be in the cart when the user accesses his/her cart using the merchant’s webpage, or vice versa. As another example, a merchant may have an online store hosted on an online marketplace. In one embodiment, control logic 301 and cart identification module 303 may provide the capability for a product stored in a user’s cart using a merchant’s mobile app or webpage to be available in the user’s cart at the online marketplace website. Likewise, control logic 301 and cart identification module 303 may provide the capability for a product stored in a user’s cart at an online marketplace, to be available at a respective merchant’s mobile app or webpage.

The tracking of each instance of a cart by control logic 301 and cart identification module 303 may further involve tracking user actions. For example, if a user scans an item in a physical store but does not proceed to purchase, control logic 301 and cart identification module 303 may note the product as being added to a cart and then removed. Similarly, for online shopping carts, control logic 301 and cart identification module 303 may detect if a user stores a product in an online cart, and later removes the product from the online cart.

In one embodiment, control logic 301 and product module 305 may detect and identify each product added into a cart. The identification of the product may involve any type of product identifier. Control logic 301 and product module 305 may further generate product categories and categorize each product in the cart. The categories may refer to comparable or interchangeable products (e.g., products that may serve as replacements for one another). Various kinds of cereal may be one example of comparable products in a “cereal” category, where each individual cereal product may be interchangeable with another. Alternately or in addition, the categories may refer to products that are related or purchased together (e.g., products that may be used in conjunction with one another). For example, cereal and milk may be categorized together as related products in a “breakfast foods” category. The categories may be generated by market settings aggregated transaction data from a population of users, merchants, or financial institutions, etc. In one embodiment, the control logic 301 and product module 305 may detect a new product and assign one or more category labels to the product. For example, a new type of cereal may be tagged with category labels including, “cereal,” “granola,” “breakfast,” “snack,” “health food,” etc. The cereal may further be tagged with product identification labels, including the cereal brand or any cereals similar to the cereal. Control logic 301 and product module 305 may further add, remove, or revise category labels as more transaction data is received. For example, control logic 301 and product module 305 may detect that a certain cereal is usually purchased with almond milk, rather than cows’ milk. Control logic 301 and product module 305 may then update the label to include “gluten-free”, “lactose intolerant”, or “vegan” so that the cereal may be associated with other cereals or products that may be geared to a specialized demographic.

In one embodiment, control logic 301 and promotions module 307 may detect a user’s application of any promotions to a purchase. For example, control logic 301 and promotions module 307 may track usage of any coupons, referrals from partner sites, promotional codes, membership discounts, merchants‘ offers, rebates, etc. In one embodiment, control logic 301 and promotions module 207 may track online activity of at least one user or at least one merchant. Online activity may include exposure to or offer of marketing assets, advertisements, offers, coupons, website, as well as online searching, and so forth. Such online activity may be tracked and logged by a data aggregator computing system. In some embodiments, at least a portion of the data aggregator functionality is performed by a third party service.

Control logic 301 and promotions module 307 may further track sales offered by a merchant associated with the cart, including promotions on all products (e.g., 20% off all items), sales on given merchants’ categories of products (e.g., 20% off all clearance items, 20% off all new items, etc.), or sales on certain products by the manufacturer (e.g., 20% off items of a particular brand, 20% off selected products of the particular brand, 20% off products of a given collection, 20% off a limited edition product or set, etc.).

In one embodiment, control logic 301 and inventory module 309 may evaluate product availability. For example, control logic 301 and inventory module 309 may determine if the product is in low stock, the likelihood of restocking, the timing of restocking, etc. In one embodiment, control logic 301 and inventory module 309 may provide insight into whether a customer will wait for the product to be restocked, if the customer will opt for a comparable replacement product, or if the customer will abandon the transaction entirely, e.g., neither buying the product, waiting for the product to be restocked, or purchase a similar product.

In one embodiment, control logic 301 and pricing module 311 may determine, at what price, a user opts to purchase a product. In one scenario, users may keep a product in a cart for an extended amount of time without purchasing the product. The control logic 301 and pricing module 311 may indicate the price at which a user opts to purchase the product. Alternately or in addition, control logic 301 and pricing module 311 may monitor the product’s price, as offered by other merchants, as well as any fluctuations in the product’s price. Control logic 301 and pricing module 311 may further compare the price of the product in the cart (of a given merchant), compared to the price of the product offered by other merchants. Control logic 301 and pricing module 311 may then serve as an indicator of a user’s loyalty or affiliation to a merchant, relative to the pricing of the product. For example, control logic 301 and pricing module 311 may detect that a user purchases consistently purchases products from “Merchant A,” despite Merchant A’s prices not being the lowest on the market. In this way, control logic 301 and pricing module 311 may indicate the user’s affiliation to the merchant. The merchant may then target this type of user with special promotions or ensure that this user’s transactions are less likely tagged for fraud, due to recognizing the user as a loyal customer of the merchant.

FIG. 3B is a block diagram of an exemplary model of a transaction platform for tracking characteristics of purchase transactions related to products stored in a cart, according to an exemplary embodiment of the present disclosure. In one embodiment, transaction platform 238 may communicate with a fraud detection computing system 231 and authorization processor 233 over payment network 230 (e.g., using any suitable modem, wireless adapter, etc.). As shown in FIG. 3B, transaction platform 238 may include control logic 401, purchase module 403, carryover module 405, payment module 407, tender usage module 409, timing module 411, and location module 413. Control logic 401 may direct the functions and interactions among the various modules.

The transaction platform 238 may access and aggregate transaction data of a plurality of carts. The following description of the transaction platform is written to pertain to a single cart, with the understanding that the capabilities of the transaction platform may be applied to at least one cart of the plurality of carts accessible to the transaction platform. In one embodiment, the transaction platform may detect authorization requests and/or authorization approvals of one or more payment vehicles associated with a particular user, data on transactions completed using one or more of the payment vehicles, authorization requests that do not have corresponding completed transaction data, etc. Based on the authorization requests or completed purchase transactions, transaction platform 238 may evaluate various elements of a transaction, as described below.

In one embodiment, control logic 401 and purchase module 403 may receive transaction data related to a cart and detect, of the products stored in the cart, which products were purchased. For example, control logic 401 and purchase module 403 may identify one or more product identifiers of a product in the cart and determine whether transaction data or payment data includes at least one of the identified product identifiers. In one embodiment, control logic 401 and purchase module 403 may further determine or assign a category designation for at least one of the purchased products. For example, if a tent is among the purchased products, control logic 401 and purchase module 403 may assign a category, e.g., “camping” or “vacation.” The category may further include related products or products that are commonly purchased together with the purchased product. For example, products in a “camping” category may include bug repellant, sun screen, backpacks, hiking boots, socks, sleeping bags, rain gear, etc.

Alternately or in addition, control logic 401 and purchase module 403 may determine category designations of interchangeable, similar, or comparable products. For example, products in the same category as “tent” may include tents of a size, design, function, and/or price similar to the tent stored in the cart. The category may be based on designations provided by manufacturer(s), merchant(s), user(s), historical data, etc. For example, merchants or manufacturers may provide alternative products when one product is sold out or when a product is displayed (e.g., in a brick and mortar store). As another example, users and/or historical data of users’ transactions may provide information on products that may be interchangeable, similar, or comparable, based on products that users choose when aiming to replace a product. For example, users may switch between specific products or brands when buying napkins every week or so. Control logic 401 and purchase module 403 may recognize that users buy any variant of napkins, depending on availability, pricing, promotions, etc. Control logic 401 and purchase module 403 may then assign the category, “napkin” to each of the variant(s). In other words, all of the variants of napkins may be recognized by control logic 401 and purchase module 403 to all be in the category, “napkins.” Control logic 401 and purchase module 403 may recognize a product as belonging to several categories, including overlapping categories or subcategories. For example, “napkins” may be part of the category, “paper products.” Subcategories of “napkins” may include “decorative”, “special event”, “daily use,” “birthday,” etc.

In one embodiment, control logic 401 and carryover module 405 may detect products that remain in a cart after a user purchased other products in the cart. Users may store items in a cart while they are waiting for a sale or promotion, mulling over whether to purchase the item, waiting for a special occasion, waiting for or testing out a similar product, waiting for a paycheck, etc. Control logic 401 and carryover module 405 may track how many times a product remains, or is “carried over,” when a user completes a purchase. For example, a user may add a pair of headphones, a coat, as well as household items (e.g., toiletries) in a cart. The user may complete a transaction purchasing the household items, while the headphones and coat remain. A month later, the user may again add household items to the cart so that the cart contains headphones, the coat, and the newly added household items. This time, the user may purchase the coat and the newly added household items in a transaction. The user may never purchase the headphones (e.g., the user may remove the headphones from the cart or the headphones may be unavailable from a merchant/vendor for being discontinued or out of stock), or the user may purchase the headphones many months later. In this type of scenario, control logic 401 and carryover module 405 may detect that the headphones remained in the cart for an extended amount of time, or for multiple transactions. Control logic 401 and carryover module 405 may also detect that the coat was “carried over” only one transaction. For physical stores, control logic 401 and carryover module 405 may apply where merchandise is reserved or held for a particular user.

In one embodiment, control logic 401 and carryover module 405 may provide an understanding of user habits, e.g., by developing aggregated data on a user’s habits in storing products in a cart. For example, control logic 401 and carryover module 405 may generate user profiles with respect to items purchased relative to items carried over. One profile may indicate that a user may habitually store many items in a cart and think over the decision for several weeks before proceeding to purchase. Another profile may indicate that a user generally purchases any items that he/she adds to a cart. Yet another profile may indicate that a user typically adds many products to a cart, but many of the products in the cart never be purchased.

In one embodiment, control logic 401 and carryover module 405 may provide an understanding of the popularity or “success” of products, e.g., by developing aggregated data on how often a product is a carryover product, agnostic to the cart or user. For example, control logic 401 and carryover module 405 may detect that one model of a baby carrier is stored in many carts, and that it is frequently a carryover item. Meanwhile, control logic 401 and carryover module 405 may detect that a comparable baby carrier is rarely a carryover product. Control logic 401 and carryover module 405 may compare a carryover rate of one product relative to a carryover rate of another, comparable product and provide a ranking of each product’s relative popularity.

Control logic 401 and carryover module 405 may also detect fluctuations or changes to carryover rates. For example, many people may save a product in a cart when there is a good deal of marketing on the product. However, they may refrain from buying the product until there are many reviews or ratings on the product. At that point, carryover rate may drop since users may have more certainty in their purchase. Control logic 401 and carryover module 405 may detect the drop in carryover rate in the product and indicate a higher popularity of the product.

In one embodiment, control logic 401 and payment module 407 may detect the price at which a product was purchased, as well as the total purchase amount for the cart. In detecting the price at which a product was purchased, control logic 401 and payment module 407 may evaluate the price at which users prefer to pay for a product, or the price that users will most likely pay for a product. For example, control logic 401 and payment module 407 may observe that a first product is consistently bought immediately when that first product is discounted by 20%, while a similar, second product is frequently stored in carts until that second product is discounted by 60%. The differential treatment may be due to frequent discounts being provided on the second product and 60% discount being the price at which most users prefer to pay for the product. Control logic 401 and payment module 407 may evaluate the range of pricing in which a product is purchased for a particular user (e.g., "User A only buys product X when product X is less than $5). Control logic 401 and payment module 407 may also evaluate the range of pricing in which a product is purchased for several users, e.g., in a particular demographic. For example, control logic 401 and payment module 407 may provide the insight that university students only buy a given product when the product is discounted. As a further example, control logic 401 and payment module 407 may evaluate the aggregate data to provide a price or range of prices at which a product has the highest likelihood or frequency of being purchased.

Control logic 401 and payment module 407 may further detect the total purchase amount for cart(s), for a user, a merchant, a product line, etc. For example, control logic 401 and payment module 407 may aggregate data on the average payment related to a cart. For instance, control logic 401 and payment module 407 may detect that a furniture or home décor store may have carts where the total payments are in the ranges of thousands of dollars. Meanwhile, control logic 401 and payment module 407 may also detect that a clothing store supports carts where the total payments are in the ranges of a hundred dollars. In doing so, control logic 401 and payment module 407 may observe any aberrations in total transaction amounts. An aberration in a transaction amount may be related to a user, for example, where a payment authorization request indicates a purchase amount far higher than what a given user historically spends with the merchant. In such a case, control logic 401 and payment module 407 may provide an alert or note potential fraudulent behavior.

Alternately or in addition, aberrations in transaction amounts may provide performance evaluations. For example, if control logic 401 and payment module 407 detect that a merchant’s cart transaction amounts for a reporting quarter are much lower than expected or predicted (e.g., from the merchant’s cart transaction amounts of the prior quarter), the merchant may reevaluate their stock for why their sales are reduced. Alternately, if the cart transaction amounts are higher than expected or predicted, the merchant may also evaluate their strategy from the quarter and seek to continue their success. Merchants may also compare their transaction amounts relative to similar merchants or competitors, to benchmark their performance.

In one embodiment, control logic 401 and tender usage module 409 may track the type of tender used to complete purchases with one or more carts. In tracking the tender used in each purchase transaction, control logic 401 and tender usage module 409 may also determine when tender is changed. For example, control logic 401 and tender usage module 409 may detect if one credit card is commonly used for purchases for a particular merchant by a variety of users, but then at some point, a second credit card becomes the prevailing tender of choice. Information collected by control logic 401 and tender usage module 409 could be useful for payment vehicle providers in dissecting which plans (e.g., credit card plans) are successful.

Control logic 401 and tender usage module 409 may also identify instances of transactions that are associated with more than one payment vehicle. For example, for a single transaction, transaction data may include an authorization request associated with a first payment vehicle, a denial of the first payment vehicle, an authorization request for the transaction associated with a second payment vehicle, and data indicating that the transaction was completed using the second payment vehicle. In other words, the control logic 401 and tender usage module 409 may detect the instances in which a user switches from one form of tender (e.g., a first payment vehicle) to another form of tender (e.g., a second payment vehicle).

The control logic 401 and tender usage module 409 may detect the forms of tender that a user (or a plurality of users) may switch between, the frequency at which a user may switch tender, and the number of times that the users may switch tender. Tender switching may include, for instance, a user switching between multiple credit cards if a credit card is denied. Another form of tender switching may include switching from a credit card to a debit card, or switching from a credit card to cash. The frequency that a user may switch tender may include detecting whether a user consistently uses one payment vehicle (e.g., a first credit card) for virtually all purchases, or whether a user switches between various payment vehicles, depending on the transaction. For example, a user may use a first payment vehicle for most travel expenses, a second payment vehicle for daily expenses (e.g., groceries or hobbies), and cash for small purchases.

In one embodiment, control logic 401 and tender usage module 409 may evaluate the number of times that a user (or a plurality of users) may switch tender before abandoning a transaction. For example, the control logic 401 and tender usage module 409 may detect the number of times a user will switch tender if each form of tender is denied. For instance, one user may abandon a transaction if his/her credit card is denied. Another user may try 2-3 different credit cards or debit cards if authorization for a transaction using a first payment vehicle is denied. Yet another user may try several forms of alternate payment, in an attempt to complete the transaction rather than leaving without completing the purchase. The control logic 401 and tender usage module 409 may assign, for each user group, product, or merchant, a metric based on the observed tender-switching practices.

In one embodiment, control logic 401 and timing module 411 may track the time of each transaction. For example, control logic 401 and timing module 411 may note the time of day or time of year of a transaction. In some cases, control logic 401 and timing module 411 may further be used for user demographics evaluations, for example, in finding the age of a user making a transaction.

In one embodiment, control logic 401 and location module 413 may detect the location at which a transaction occurs. For online or virtual carts, control logic 401 and location module 413 may detect the location of a mobile device or device (e.g., computer) where a transaction is initiated by a user. For example, for a user making an online purchase in his/her home, control logic 401 and location module 413 may detect the location of the user’s home. For physical carts, control logic 401 and location module 413 may detect the store location where a transaction took place.

FIG. 3C is a block diagram of an exemplary model of abandonment scoring platform for generating a cart abandonment score, according to an exemplary embodiment of the present disclosure. In one embodiment, of abandonment scoring platform 242 may communicate with a fraud detection computing system 231 and authorization processor 233 over payment network 230 (e.g., using any suitable modem, wireless adapter, etc.). As shown in FIG. 3C, abandonment scoring platform 242 may include control logic 501, cart input module 503, transaction input module 505, subscription input module 507, aggregate module 509, analytics module 511, and score computation module 513. Control logic 501 may direct the functions and interactions among the various modules.

In one embodiment, control logic 501 and cart input module 503 may receive data from cart evaluation platform 236. Control logic 501 and transaction input module 505 may receive data from transaction platform 238. In one embodiment, control logic 501 and subscription input module 507 may receive subscription information from the subscription management platform 240.

In one embodiment, control logic 501 and aggregate module 509 may determine which data, of the data received from cart evaluation platform 236 and/or transaction platform 238, may be used to calculate a cart abandonment score. For example, for a cart abandonment score for a particular new product in its first month after being launched, control logic 501 and aggregate module 509 may determine that the data to use in calculating the cart abandonment score comprises data from the product module 305 of the cart evaluation platform 236, as well as the purchase module 403 and timing module 411 of the transaction platform 238.

Control logic 501 and aggregate module 509 may also provide a weighting scheme for the data used in calculating a cart abandonment score. For example, for a cart abandonment score for a particular new product in its first month after being launched, the primary data may be data that indicates whether the product was added to carts at all (e.g., the general interest). Accordingly, control logic 501 and aggregate module 509 may assign a high, first weight value to data from the product module 305. Secondary data for such a scenario may include data indicating that users were not only interested in the product, but that users actually bought the product. Accordingly, control logic 501 and aggregate module 509 may assign a second weight value to data from the payment module 407, the second weight value being lower than the first weight value assigned to data from the product module 305.

Further, merchants may be interested in where (e.g., in the United States), a product is most popular. In such a case, control logic 501 and aggregate module 509 may assign a third weight value to data from location module 413. The third weight value may be lower or the same as the second weight value. Alternately or in addition, product manufacturers (e.g., a brand), may be interested in which merchants are selling their products best. Manufacturers may sell their products through various merchants, and the manufacturers may wish to evaluate which merchants users choose to purchase from. In such a case, control logic 501 and aggregate module 509 may assign a third weight value to data of the cart identification module, which may include the merchant associated with each cart. Merchants may also wish for cart identification data to be used in computing a cart abandonment score, in order to benchmark their performance against similar merchants or expected performance in an industry, to evaluate which carts (e.g., app-based, website, physical store, hosted virtual store, etc.) users gravitate towards, etc.

For example, if a given merchant’s cart abandonment score is only 10% (e.g., indicating that users have a 10% likelihood or frequency of abandoning their cart(s) before purchasing an item) while its competitor’s cart abandonment score is 80%, the given merchant may conclude that it is doing well relative to its competition. The merchant may then evaluate its recent sales tactics or interfaces to try to perpetuate its success. If, however, the merchant’s cart abandonment score is higher than one or more of its competitors, the merchant may note that it may need to reevaluate its practices because its performance is lower than the expected score in that industry sector. The same evaluation may be performed to judge performance of various stores or platforms used by a single merchant. For example, a merchant may be a franchise, with several stores in different locations. The cart abandonment score may be used to see which stores are doing better than others.

In one embodiment, control logic 501 and aggregate module 509 may determine data aggregation methods and/or weighting scheme(s) based on the subscriptions received by subscription input module 507. For example, for a merchant subscriber of the financial transaction services processor 220, the control logic 501 and aggregate module 509 may provide a data aggregation and/or weighting scheme that may give the merchant a cart abandonment score conveying information on which products are purchased and which products are carried over (e.g., using data of the purchase module 403 and carryover module 405). The control logic 501 and aggregate module 509 may also provide a cart abandonment score conveying information to a merchant on prices at which users make the decision to buy a product after having the product in their cart for an extended period of time, e.g., using data from the promotions module 307, pricing module 311, purchase module 403, and carryover module 405. Merchants may use such data to evaluate the success of promotions or sales, customer loyalty programs, or their success relative to competing merchants.

As another example, for a manufacturer subscriber of the financial transaction services processor 220, the control logic 501 and aggregate module 509 may provide a data aggregation and/or weighting scheme that may give the manufacturer a cart abandonment score conveying information on which products are purchased and which products are carried over (e.g., using data of the purchase module 403 and carryover module 405). The control logic 501 and aggregate module 509 may also provide a cart abandonment score conveying information to a manufacturer on the locations with the highest concentrations of purchases of a given product (e.g., using the location module 413). Manufacturers may use this information to evaluate the success of a product. Manufacturers may also use this information towards the designs of future products.

As yet another example, for a third party vendor subscriber (e.g., a fraud analysis service or advertisement/marketing service), a financial institution subscriber, or a merchant subscriber, the control logic 501 and aggregate module 509 may generate cart abandonment scores that provide an understanding of aggregated cart abandonment habits, such that the subscriber may better detect irregular behavior that may be an indication of fraud. The data aggregated for cart abandonment scores conveying such information may include data from one or more of the pricing module 311, purchase module 403, carryover module 405, payment module 407, tender usage module 409, timing module 411, or location module 413. For example, the control logic 501 and aggregate module 509 may provide aggregated tender-switching scores or cart abandonment scores that providing an indication of user’s cart or tender usage practices at different times of the day, whether at work or at home, in a physical store, buying at a virtual store, etc. For example, cart abandonment scores may show that users collectively add items to carts between 9am to 5pm and make purchases between 8pm and 10pm. Cart abandonment scores may show record low abandonment and high transaction amounts on Friday and Saturday between midnight and 4am. In one embodiment, the subscriber may authorize or decline a transaction/purchase/payment request based on the cart abandonment score. Alternately or in addition, a subscriber may design marketing campaigns based on cart abandonment scores and practices.

In one embodiment, control logic 501 and aggregate module 509 may include preset data aggregation methods and/or weighting scheme(s). In another embodiment, control logic 501 and aggregate module 509 may include initial data aggregation methods and/or weighting scheme(s), and then proceed to update the aggregation methods and/or weighting scheme(s) using machine learning and/or statistical methods and data.

In one embodiment, control logic 501 and analytics module 511 may update the data aggregation or weighting schemes of the aggregate module 509. In one embodiment, subscribers or users may interact with a user interface or dashboard offering options or displays on various cart abandonment scores. Control logic 501 and analytics module 511 may update the data aggregation or weighting schemes of the aggregate module 509 based on subscriber or user interactions. In one embodiment, control logic 501 and analytics module 511 may track and analyze subscriber needs, usage information on various cart abandonment scores, possible usages of cart abandonment scores, etc. In one embodiment, control logic 501 and analytics module 511 may also find additional analytics for the financial transaction services processor 220.

In one embodiment, control logic 501 and score calculation module 513 may calculate one or more cart abandonment scores. As previously discussed, the cart abandonment scores may be computed using the data aggregation methods and/or weighting scheme(s) of the aggregate module 509, subscriber information, subscriber settings, or a combination thereof. The visualization platform 246 of the financial transaction services processor 220, control logic 501, and score calculation module 513 may produce one or more user interfaces, dashboards, or reports of cart abandonment scores. The scores may be in the form of numbers, colors, bar graphs, pie charts, or any graphic available to be part of a visualization.

FIG. 1-3C, and the discussion above provide a brief, general description of a suitable computing environment in which the present disclosure may be implemented. In one embodiment, any of the disclosed systems and/or methods may be executed by or implemented by a computing system consistent with or similar to that depicted in FIG. 1-3C. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

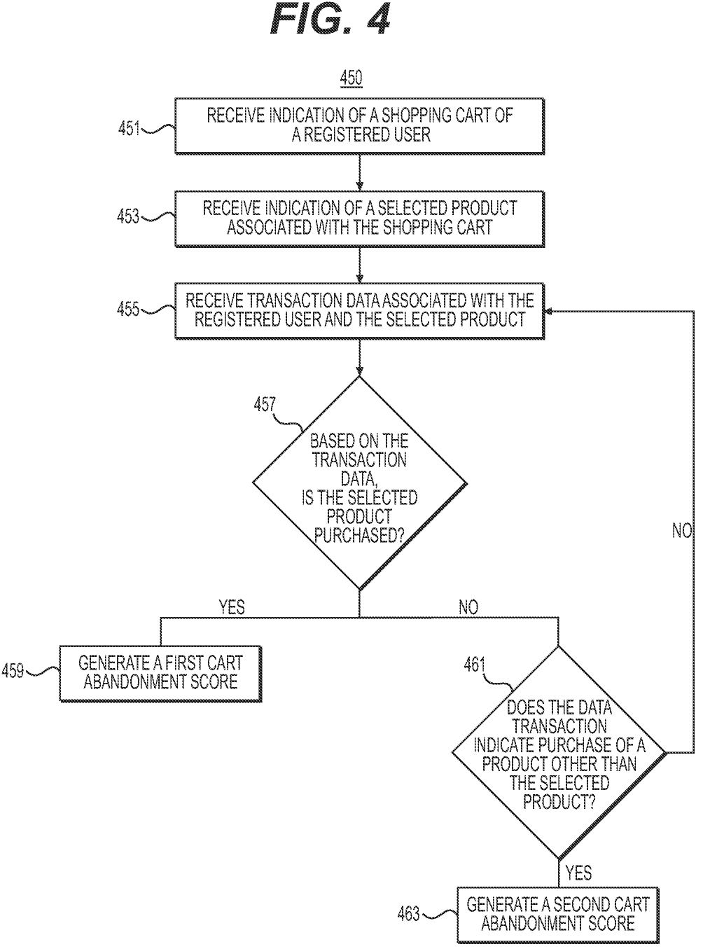

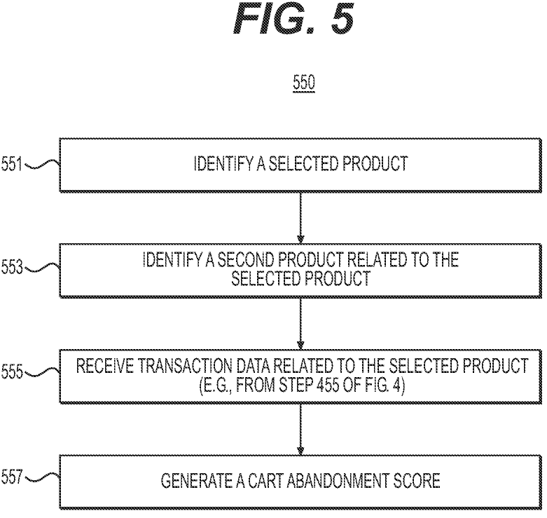

FIG. 4 depicts a general exemplary method for generating aggregated cart abandonment scores. FIG. 5 depicts an exemplary method of generating a particular type of aggregated cart abandonment score. In particular, FIG. 5 includes a detailed exemplary method for generating cart abandonment scores for a particular product (e.g., the selected product of FIG. 4), a product category, or product related to the particular product.

FIG. 4 is a flow diagram of an exemplary method 450 for generating aggregated cart abandonment scores, according to an exemplary embodiment of the present disclosure. Step 451 may include detecting or receiving indication of an existing shopping cart of a user. The user may be a user registered on a merchant interface (e.g., a merchant’s website or app). Alternately or in addition, the user may be a user registered in a merchant’s loyalty program, e.g., where registration may be detected upon using a scanning device of the merchant or upon scanning a cart of the merchant. In one embodiment, step 451 may further include identifying a merchant associated with the shopping cart, if the cart was first detected using user information.

Alternately or in addition, step 451 may include detecting or receiving indication of an existing shopping cart of a merchant. Merchants may offer shopping carts in various forms, e.g., on an online marketplace hosting several merchants, the merchant’s own website or app, a physical cart in a store, etc. Step 451 may include identifying a plurality of shopping carts associated with a given merchant. Step 451 may further include identifying one or more users associated with a shopping cart of a merchant. For example, a cart set up as a gift registry may be associated with several users. Step 451 may include identifying the users associated with the gift registry. Step 451 may include identifying, of the plurality of shopping carts associated with a given merchant, a subset of shopping carts associated with a user.

In one embodiment, step 453 may include detecting or receiving indication of a selected product associated with the existing shopping cart. For example, each product may be associated with one or more identifiers. Step 453 may include detecting the products in a shopping cart, including all of the contents in a shopping cart. An indication of the selected product being placed in a shopping cart may include an detecting a product identifier being associated with a cart identifier denoting the shopping cart of a particular user registered as a customer of a respective merchant.

In one embodiment, step 455 may include receiving transaction data associated with the registered user, or a plurality of registered users. Alternately or in addition, step 455 may include receiving transaction data associated with one or more detected shopping carts. Transaction data may comprise entries including, for each transaction of the transaction data, request(s) for authorization of payment, approval(s) of request(s) for payment, denial(s) of request(s) for authorization of payment, tender used in payment (e.g., associated with the registered user, associated with the merchant, used for a purchase, etc.), number times a user changed the form of tender offered (prior to a purchase/payment being approved), payment amount, promotion(s) used, frequency/time/date the transaction, or a combination thereof.

In one embodiment, step 457 may include determining, based on the received transaction data, whether the selected product was purchased. For example, step 457 may include detecting purchase data of the selected product, from the transaction data. In one embodiment, step 459 may include generating at first cart abandonment score if the transaction data indicates purchase of the selected product.

In one embodiment, step 461 may include determining, based on the received transaction data, whether a product other than the selected product was purchased. If so, a second cart abandonment score may be generated (e.g., step 463). In such a case, the second cart abandonment score will comprise a value different from the value of the first cart abandonment score. The first cart abandonment score or second cart abandonment score may comprise a performance metric of the merchant, the selected product (e.g., as a measure of popularity of the product), a form of tender, or a combination thereof. If the determination of step 461 yields no indication of the purchase of any product (e.g., purchase of the selected product or a product other than the selected product), the method may include continuing to monitor transaction data. In such a case, a cart abandonment score may not be provided until transaction data indicates some purchase. The cart abandonment score of method 450 may be aggregated with the scores of multiple shopping carts (and multiple users).

In one embodiment, a transaction may be authorized or denied based on either the first cart abandonment score or the second cart abandonment score. For example, a merchant may deny a transaction (e.g., restocking a given product) if a cart abandonment score is below a threshold cart abandonment score. Alternately or in addition, a merchant may authorize the transaction of restocking the product if the cart abandonment score is higher than a threshold cart abandonment score.

FIG. 5 is a flow diagram of an exemplary method 550 for generating cart abandonment scores for a particular product (e.g., the selected product of FIG. 4), a product category, or product related to the particular product, according to an exemplary embodiment of the present disclosure. In one embodiment, step 551 may include receiving a selection of a product or identifying a selected product. Step 553 may include identifying a second product related to the selected product, either because the product may be used in conjunction with the selected product, the product has been bought together with the selected product, the product is comparable to the selected product, the product is recognized as a replacement or interchangeable with the selected product, etc. Step 555 may include receiving transaction data related to the selected product (e.g., from step 555 of the method of FIG. 4) or receiving transaction data related to the second product. Step 557 may include generating a cart abandonment score as a performance metric of the selected product or generating a cart abandonment score as a performance metric of the product. In some cases, the cart abandonment score of step 557 in this method 550 may be either the first cart abandonment score or the second cart abandonment score of method 450.

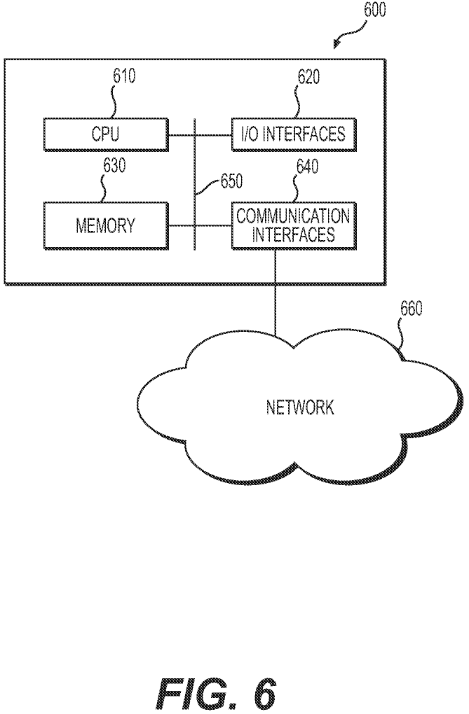

The systems and processes described above may be performed on or between one or more computing devices. FIG. 6 illustrates an example computing device. A computing device 600 may be a server, a computing device that is integrated with other systems or subsystems, a mobile computing device such as a smart phone, a cloud-based computing ability, and so forth. The computing device 600 may be any suitable computing device as would be understood in the art, including without limitation, a custom chip, and embedded processing device, a tablet computing device, a POS terminal associated with a merchant, a back-office system of a merchant, a personal data assistant (PDA), a desktop, laptop, microcomputer, and minicomputer, a server, a mainframe, or any other suitable programmable device. In various embodiments disclosed herein, a single component may be replaced by multiple components and multiple components may be replaced by single component to perform a given function or functions. Except where such substitution would not be operative, such substitution is within the intended scope of the embodiments.

The computing device 600 may include a processor 610 that may include any suitable type of processing unit, for example a general-purpose central processing unit (CPU), a reduced instruction set computer (RISC), a processor that has a pipeline or multiple processing capability including having multiple cores, a complex instruction set computer (CISC), a digital signal processor (DSP), application specific integrated circuits (ASIC), a programmable logic devices (PLD), and a field programmable gate array (FPGA), among others. The computing resources may also include distributed computing devices, cloud computing resources, and virtual computing resources in general.

The computing device 600 may also include one or more memories 630, for example a read-only memory (ROM), random access memory (RAM), cache memory associated with the processor 610, or other memory such as dynamic RAM (DRAM), static RAM (SRAM), programmable ROM (PROM), electrically erasable PROM (EEPROM), flash memory, a removable memory card or disc, a solid-state drive, and so forth. The computing device 600 also includes storage media such as a storage device that may be configured to have multiple modules, such as magnetic disk drives, floppy drives, tape drives, hard drives, optical drives and media, magneto-optical drives and media, compact disk drives, Compact Disc Read Only Memory (CD- ROM), compact disc recordable (CD-R), Compact Disk Rewritable (CD-RW), a suitable type of Digital Versatile Disc (DVD) or BluRay disc, and so forth. Storage media such as flash drives, solid-state hard drives, redundant array of individual discs (RAID), virtual drives, networked drives and other memory means including storage media on the processor 610, or memories 630 are also contemplated as storage devices. It may be appreciated that such memory may be internal or external with respect to operation of the disclosed embodiments. It may be appreciated that certain portions of the processes described herein may be performed using instructions stored on a computer readable medium or media that direct computer system to perform the process steps. Non-transitory computable-readable media, as used herein, comprises all computer-readable media except for transitory, propagating signals.

One or more networking communication interfaces 640 may be configured to transmit to, or receive data from, other computing devices 600 across a network 660. The network and communication interfaces 640 may include an Ethernet interface, a radio interface, a Universal Serial Bus (USB) interface, or any other suitable communications interface and may include receivers, transmitter, and transceivers. For purposes of clarity, a transceiver may be referred to as a receiver or a transmitter when referring to only the input or only the output functionality of the transceiver. Example communication interfaces 640 may include wire data transmission links such as Ethernet and TCP/IP. The communication interfaces 640 may include wireless protocols for interfacing with private or public networks 660. For example, the network and communication interfaces 640 and protocols may include interfaces for communicating with private wireless networks such as Wi-Fi network, one of the IEEE 802.11x family of networks, or another suitable wireless network. The network and communication interfaces 640 may include interfaces and protocols for communicating with public wireless networks 660, using for example wireless protocols used by cellular network providers, including Code Division Multiple Access (CDMA) and Global System for Mobile Communications (GSM). A computing device 600 may use network and communication interfaces 640 to communicate with hardware modules such as a database or data store, or one or more servers or other networked computing resources. Data may be encrypted or protected from unauthorized access.

In various configurations, the computing device 600 may include a system bus 650 for interconnecting the various components of the computing device 600, or the computing device 600 may be integrated into one or more chips such as programmable logic device or application specific integrated circuit (ASIC). The system bus 650 may include a memory controller, a local bus, or a peripheral bus for supporting input and output device interfaces 620, and communication interfaces 640. Example input and output interfaces or devices 620 include keyboards, keypads, gesture or graphical input devices, motion input devices, touchscreen interfaces, one or more displays, audio units, voice recognition units, vibratory devices, computer mice, and any other suitable user interface.

The processor 610 and memory 630 may include nonvolatile memory for storing computable-readable instructions, data, data structures, program modules, code, microcode, and other software components for storing the computer-readable instructions in non-transitory computable-readable mediums in connection with the other hardware components for carrying out the methodologies described herein. Software components may include source code, compiled code, interpreted code, executable code, static code, dynamic code, encrypted code, or any other suitable type of code or computer instructions implemented using any suitable high-level, low-level, object-oriented, visual, compiled, or interpreted programming language.

These and other embodiments of the systems and methods may be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems may be made and used. A number of modifications, including substitutions of systems between or among examples and variations among combinations may be made. Those modifications and variations should be apparent to those of ordinary skill in this area after having read this disclosure.

It is intended that the specification and examples be considered as exemplary only, with a true scope and spirit of the invention being indicated by the following claims.

What is claimed is:

1. A computer-implemented method of generating analytics for products placed in virtual or physical shopping carts, the method comprising:
detecting, using a processor of a purchase tracking computing system, a shopping cart associated with a registered user;
identifying, using the processor, a purchase price that a selected product placed in the shopping cart was purchased at;
determining, using the processor and based on the identifying, at least one trend associated with the selected product; and
performing, based on the determined at least one trend, an action in relation to the selected product.

2. The method of claim 1, wherein the determining the at least one trend comprises ascertaining that the purchase price of the selected product corresponds to a preferred purchase price for the selected product and wherein the ascertaining comprises:
identifying that the selected product was purchased subsequent to implementation of a price reduction for the selected product from a higher price to the purchase price.

3. The method of claim 2, wherein the determining the at least one trend further comprises recognizing that a preferred price reduction for a second product, similar to the selected product, is greater than the price reduction for the selected product and wherein the recognizing comprises:
identifying that another price reduction, larger than the price reduction for the selected product, is more frequently issued for the second product than the selected product; and
identifying that the second product is purchased subsequent to implementation of the another price reduction for the second product.

4. The method of claim 1, further comprising identifying a demographic category associated with the registered user and wherein the determining the at least one trend comprises ascertaining a preferred price range for the selected product for a set of registered users associated with the demographic category.

5. The method of claim 1, wherein the determining the at least one trend comprises identifying, for a merchant selling the selected product, a common price range for a total purchase transaction based on a product sales category associated with the merchant and further comprising:
identifying a total purchase amount for the shopping cart; and
ascertaining whether the total purchase amount for the shopping cart is within the common price range based on the product sales category associated with the merchant; and
wherein the performing the action comprises performing, responsive to ascertaining that the total purchase amount for the shopping cart is not within the common price range, an alert of potential fraud to an authority.

6. The method of claim 5, wherein the performing the action comprises providing, responsive to ascertaining that the total purchase amount for the shopping cart is not within the common price range, an alert of potential fraud to an authority.

7. The method of claim 5, wherein the performing the action comprises affecting, responsive to ascertaining that the total purchase amount for the shopping cart is lower than the common price range, a quarterly performance evaluation for the merchant.

8. A decentralized computer system for generating analytics for products placed in virtual or physical shopping carts, the system comprising:
a data storage device storing instructions for generating analytics for products placed in virtual or physical shopping carts; and
a processor configured to execute the instructions to perform a method including:
detecting, using a processor of a purchase tracking computing system, a shopping cart associated with a registered user;
identifying, using the processor, a purchase price that a selected product placed in the shopping cart was purchased at;
determining, using the processor and based on the identifying, at least one trend associated with the selected product; and
performing, based on the determined at least one trend, an action in relation to the selected product.

9. The system of claim 8, wherein the processor configured for determining the at least one trend is further configured for ascertaining that the purchase price of the selected product corresponds to a preferred purchase price for the selected product and wherein the processor configured for ascertaining is further configured for:
identifying that the selected product was purchased subsequent to implementation of a price reduction for the selected product from a higher price to the purchase price.

10. The system of claim 9, wherein the processor configured for determining the at least one trend is further configured for recognizing that a preferred price reduction for a second product, similar to the selected product, is greater than the price reduction for the selected product and wherein the processor configured for recognizing is further configured for:
identifying that another price reduction, larger than the price reduction for the selected product, is more frequently issued for the second product than the selected product; and
identifying that the second product is purchased subsequent to implementation of the another price reduction for the second product.

11. The system of claim 8, wherein the processor is further configured for identifying a demographic category associated with the registered user and wherein the processor configured for determining the at least one trend is further configured for ascertaining a preferred price range for the selected product for a set of registered users associated with the demographic category.

12. The system of claim 8, wherein the processor configured for determining the at least one trend is further configured for identifying, for a merchant selling the selected product, a common price range for a total purchase transaction based on a product sales category associated with the merchant and wherein the processor is further configured for:
identifying a total purchase amount for the shopping cart; and
ascertaining whether the total purchase amount for the shopping cart is within the common price range based on the product sales category associated with the merchant.

13. The system of claim 12, wherein the processor configured for performing the action is further configured for providing, responsive to ascertaining that the total purchase amount for the shopping cart is not within the common price range, an alert of potential fraud to an authority.

14. The system of claim 12, wherein the processor configured for performing the action is further configured for affecting, responsive to ascertaining that the total purchase amount for the shopping cart is lower than the common price range, a quarterly performance evaluation for the merchant.

15. A non-transitory machine-readable medium storing instructions that, when executed by a server, cause the server to perform a method for generating analytics for products placed in virtual or physical shopping carts, the method including:
detecting, using a processor of a purchase tracking computing system, a shopping cart associated with a registered user;
identifying, using the processor, a purchase price that a selected product placed in the shopping cart was purchased at;
determining, using the processor and based on the identifying, at least one trend associated with the selected product; and
performing, based on the determined at least one trend, an action in relation to the selected product.

16. The machine readable medium of claim 15, wherein the determining the at least one trend comprises ascertaining that the purchase price of the selected product corresponds to a preferred purchase price for the selected product and wherein the ascertaining comprises:
identifying that the selected product was purchased subsequent to implementation of a price reduction for the selected product from a higher price to the purchase price.

17. The machine readable medium of claim 16, wherein the determining the at least one trend further comprises recognizing that a preferred price reduction for a second product, similar to the selected product, is greater than the price reduction for the selected product and wherein the recognizing comprises:
identifying that another price reduction, larger than the price reduction for the selected product, is more frequently issued for the second product than the selected product; and
identifying that the second product is purchased subsequent to implementation of the another price reduction for the second product.

18. The machine readable medium of claim 15, wherein the method further comprises identifying a demographic category associated with the registered user and wherein the determining the at least one trend comprises ascertaining a preferred price range for the selected product for a set of registered users associated with the demographic category.

19. The machine readable medium of claim 15, wherein the determining the at least one trend comprises identifying, for a merchant selling the selected product, a common price range for a total purchase transaction based on a product sales category associated with the merchant and further comprising:
identifying a total purchase amount for the shopping cart; and
ascertaining whether the total purchase amount for the shopping cart is within the common price range based on the product sales category associated with the merchant.

20. The machine readable medium of claim 19, wherein the performing the action comprises providing, responsive to ascertaining that the total purchase amount for the shopping cart is not within the common price range, an alert of potential fraud to an authority.
